(19) United States
(12) Patent Application Publication
(10) Pub. No.: US 2010/0030953 A1
(43) Pub. Date: Feb. 4, 2010

(54) HIGH-SPEED SOLID STATE STORAGE SYSTEM HAVING A NON-VOLATILE RAM FOR RAPIDLY STORING ADDRESS MAPPING INFORMATION

(76) Inventors: Mun Seok NOH, Gyeonggi-do (KR); Dae Hee YI, Seoul (KR)

Correspondence Address: LADAS & PARRY LLP, 224 SOUTH MICHIGAN AVENUE, SUITE 1600, CHICAGO, IL, 60604, US

(21) Appl. No.: 12/395,778

(22) Filed: Mar. 2, 2009

(30) Foreign Application Priority Data
Aug. 1, 2008 (KR) 10-2008-0075526

(51) Int. Cl. G06F 12/10; G06F 12/14; G06F 12/08

(52) U.S. Cl. 711/104; 711/206; 711/101; 711/156; 711/E12.103; 711/E12.058; 711/E12.016

(57) ABSTRACT

A solid state storage system incorporating a non-volatile randome access memory (NVRAM) that exhibits a reduced storage time is presented. The solid state storage system includes a memory area, a controller, and an information storage area. The controller is configured to control the memory area. The information storage area controlled by the controller and is configured to store logical address mapping information and physical address mapping information of the memory area.

### CROSS-REFERENCES TO RELATED PATENT APPLICATION

The present application claims priority under 35 U.S.C 119(a) to Korean Application No. 10-2008-0075526, filed on Aug. 1, 2008, in the Korean Intellectual Property Office, which is incorporated herein by reference in its entirety as set forth in full.

### BACKGROUND

1. Technical Field

The embodiment described herein relates to a solid state storage system, and more particularly, to a high-speed solid state storage system having a non-volatile random access for rapidly storing address mapping information.

2. Related Art

In general, non-volatile memories have been used as memories for portable information apparatuses. In recent years, instead of a hard disk drive (HDD), a solid state drive (SSD) using a NAND flash memory has begun to be used in a personal computer (PC). Therefore, it is anticipated that the SSD will make further inroads into the share market associated with HDDs.

In a solid state storage system, such as the SSD, logical addresses and physical addresses of a data storage area are mapped through a flash translation layer (FTL) conversion. As well known, since address mapping information is working information that a micro controller unit (MCU) needs to continuously refer to during the execution of commands, the address mapping information needs to be maintained, while the particular solid state storage system operates. At this time, the above information is temporarily stored in a working memory area that includes an SRAM having a relatively fast cell access speed. However, even after a power supply device is turned off, the address mapping information still needs to be maintained in order to know a data storage location in a flash memory. For this reason, mapping information of a working memory area needs to be stored in a flash memory area.

Meanwhile, the life time of a NAND flash memory is restricted due to relatively slow erase cycle or an erase count of a block. Since this erase count information is also information that is required by the MCU for block allocation during the execution of commands, the erase count information is arbitrarily stored in the working memory. Further, since the erase count information is needed when the power supply device is turned on, the erase count information needs to be stored in a portion of the NAND flash memory area.

In addition to the above information, command signals and control related codes that are needed during the execution of commands are arbitrarily stored in the working memory, such that the MCU refers to the corresponding information, if necessary. For this reason, processes of updating and storing working information (for example, address mapping information and erase count information), which needs to be maintained even after the power supply device is turned off, becomes relatively complicated. As described above, during a process in which predetermined information is stored from the working memory area to a portion of the NAND flash memory area, a large amount of time may be consumed due to the relatively slow writing speeds NAND flash memory cells.

For this reason, storage time of block address mapping information and block erase count information may degrade the performance of the solid state storage system. Further, if a portion of a memory area is allocated to store the above information, area efficiency of the memory area may be degraded.

### SUMMARY

A solid state storage system that can operate at a relatively high speed and having an improve area memory area efficiency is disclosed herein.

In one aspect provides a solid state storage system that includes a memory area; a controller configured to control the memory area; and an information storage area configured to be controlled by the controller and store logical address mapping information and physical address mapping information of the memory area.

Another aspect provides a solid state storage system that includes a memory area; a controller configured to control the memory area; and an information storage area configured to be controlled by the controller and store erase count information of a block in the memory area.

According to one embodiment, address mapping information can be stored at a relatively high speed. In particular, information that is needed and used is maintained even though a power supply is turned off can be stored at a high speed by storing the address mapping information and erase count information in a non-volatile random access memory (NVRAM). It is possible to reduce storage time of the address mapping information and the erase count information by using a simple storage method using a next-generation non-volatile memory. Further, since a portion of a main memory area does not need to be additionally allocated as an information storage area, limited resources can be efficiently used.

These and other features, aspects, and embodiments are described below in the section “Detailed Description.”

### BRIEF DESCRIPTION OF THE DRAWINGS

Features, aspects, and embodiments are described in conjunction with the attached drawings, in which:

FIG. 1 is a block diagram of an exemplary solid state storage system according to one embodiment;

FIG. 2 is a block diagram of an exemplary information storage area shown in FIG. 1;

FIG. 3 is a conceptual block diagram of a relationship between an information storage area, a buffer unit, and an MCU shown in FIG. 2; and

FIG. 4 is a block diagram of a relationship with an information storage area according to another embodiment.

### DETAILED DESCRIPTION

Hereinafter, a solid state storage system according to one embodiment will be described with reference to the accompanying drawings.

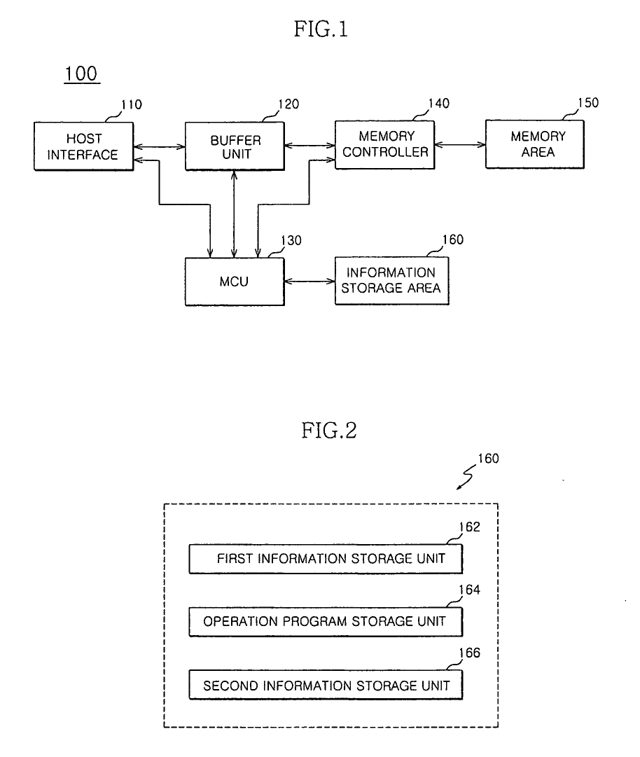

FIG. 1 is a block diagram of an exemplary solid state storage system 100 according to one embodiment.

Referring to FIG. 1, the solid state storage system 100 can be configured to include a host interface 110, a buffer unit 120, a micro controller unit (MCU) 130, a memory controller 140, a memory area 150, and an information storage area 160.

First, the host interface 110 can be connected to the buffer unit 120, and can transmit and receive control commands, address signals, and data signals between an external host (not shown) and the buffer unit 120. An interface method between the host interface 110 and the external host (not shown) can be any interface method such as those selected from the group consisting of a serial advanced technology attachment (SATA) method, a parallel advanced technology attachment (PATA) method, an SCSI method, a method using an express card, and a PCI-Express method, which are only exemplary.

The buffer unit 120 can buffer output signals from the host interface 110 or data from the memory area 150. Further, the buffer unit 120 can buffer output signals from the MCU 130 for providing the buffered signals to the host interface 110 and the memory controller 140. The buffer unit 120 can be called a common memory for buffering and can be exemplified as a buffer using a static random access memory (SRAM).

The MCU 130 can exchange control commands, address signals, and data signals with the host interface 110 or control the memory controller 140 using these signals. In addition, the MCU 130 can control the information storage area 160. Accordingly, the MCU 130 can load information that is temporarily stored in the buffer unit 120 and control the operation, or perform a control operation such that a command executed result is stored in the information storage area 160.

The memory controller 140 can select a predetermined NAND flash memory element (not shown) from a plurality of NAND flash memory elements in the memory area 150, and provide write, delete, and read commands to the selected NAND flash memory element.

The memory area 150 can be controlled by the memory controller 140, and write, delete, and read operations of data can be performed on the memory area 150.

The information storage area 160 can store an operation program, a control code, and address mapping information, which are used while commands are executed by the MCU 130. The information storage area 160 can be accessed from the MCU 130 according to a request from a host and can provide information that is needed while the commands are executed. In particular, in order to maintain predetermined information of the buffer unit 120 even when a power supply device is turned off, the information can be stored in the information storage area 160. Specifically, the information storage area 160 can be configured to include an information storage area where information is maintained only while the power supply device is turned on and an information storage area where information is maintained even after the power supply device is turned off.

The information storage area 160 will be described in detail with reference to the accompanying drawings.

FIG. 2 is a block diagram of an exemplary information storage area 160 shown in FIG. 1.

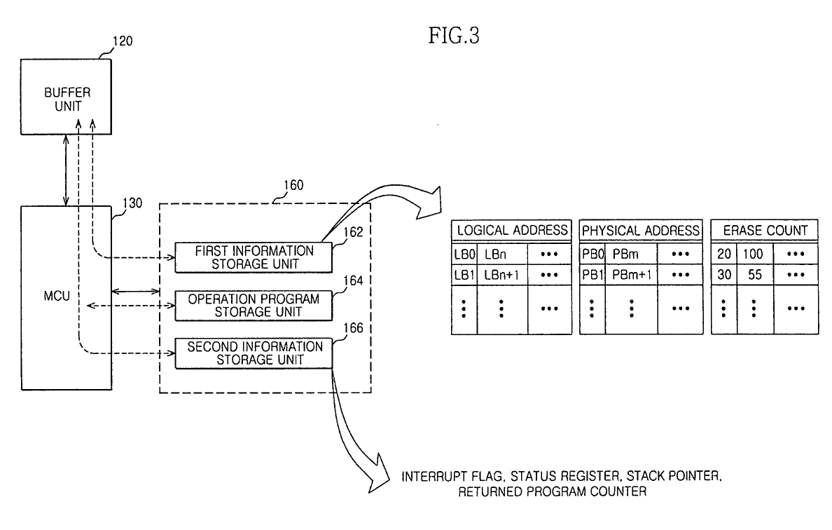

FIG. 3 is a conceptual block diagram of a relationship between an information storage area 160, a buffer unit 120, and an MCU 130 shown in FIG. 2.

Referring to FIGS. 2 and 3, the information storage area 160 can be configured to include a first information storage unit 162 and a second information storage unit 166 as working memory areas and an operation program storage unit 164.

The first information storage unit 162 can store basic information, such as address mapping information and erase count information, which is used to determine a state of the memory area (refer to reference numeral 150 of FIG. 1), not only in the case where the operation is performed but also in the case where the power supply device is turned on. As shown in the drawing, the address mapping information may be a logical address table and a physical address table, and the erase count information may be an erase count table.

The first information storage unit 162 can be configured to include a non-volatile random access memory. In this case, the non-volatile random access memory can be exemplified as a memory that has a fast cell access speed and a fast write speed. For example, examples of the non-volatile random access memory can include a ferroelectric RAM (FeRAM), a magnetic RAM (MRAM), and a phase-change RAM (PRAM). First, the FeRAM can store data using a property of a ferroelectric material. The PRAM can store data according to a form of a solid of which resistance of material is weak and a form of a liquid of which resistance of material is strong by applying a current to a specific material. The MRAM can store data using a ferromagnetic material and a property of a magnetic field, that is, properties of N and S poles.

The first information storage unit 162 will be described more specifically.

If the power supply device of the solid state storage system (refer to reference numeral 100 of FIG. 1) is turned on, the MCU 130 can load address mapping information and erase count information that are stored in the first information storage unit 162 and transmit the corresponding information to the buffer unit 120. While referring to the address mapping information and the erase count information, the host interface (refer to reference numeral 110 of FIG. 1), the memory controller (refer to 140 of FIG. 1), and the MCU 130 can perform the corresponding operation. The above information can be updated whenever the operation is performed in accordance to a command. As described above, the address mapping information can define a location where data is to be processed, and the erase count information can become a reference when blocks are allocated. Accordingly, since the above information needs to be maintained even after the power supply device is turned off, the updated address mapping information and erase count information can be stored in the first information storage unit 162 as a non-volatile memory area.

In the related art, in order to safely store the above information, a portion of a flash memory cell array is allocated and the above information is stored therein. However, since a write speed as well as an access speed are relatively slow due to a characteristic of a flash memory cell, a large amount of time is consequently needed to store the above information. That is, since the portion of the flash memory cell array corresponds to a flash memory cell area, a write time can be for example 250 microseconds in the case of an SLC and 850 microseconds in the case of an MLC. To further delay the process, a data transmission time is also needed in order to transmit data from the working memory area to the portion of the flash memory cell.

However, according to one embodiment, the information can be stored in the first information storage area 162 where a cell access speed is fast and a cell write speed is faster than that of a flash memory. Accordingly, it is possible to decrease an information storage time. For example, the access time of the non-volatile memory cell can be as fast as 30 nanoseconds and the write time thereof can be as fast as 50 nanoseconds. Further, since the portion of the memory area 150 does not need to be allocated for an information storage area, it is possible to efficiently use resources of the memory area 150.

The operation program storage unit 164 can store an operating system (hereinafter, referred to as ‘OS’) program of the solid state storage system 100. The OS program is needed to boot up the operation of the solid state storage system 100. In accordance to a command from the host (not shown), the MCU 130 can load the OS program of the operation program storage unit 164 and operate the solid state storage system 100. As well known, the operation program storage unit 164 can use a read only memory (ROM). If the power supply device is turned on, the MCU 130 can load the OS program of the operation program storage unit 164 and control driving of the solid state storage system (refer to reference numeral 100 of FIG. 1).

The second information storage unit 166 can store arbitrary information that is needed and used when the MCU 130 executes commands. The second information storage unit 166 can store control signals according to the execution of the commands, that is, an interrupt flag, a status register, a stack pointer, and a returned program counter. The above information is information needed to control work order, only while the power supply device is turned on, that is, the commands of the solid state storage system (refer to reference numeral 100 of FIG. 1) are executed. The above information does not need to be maintained even after the power supply device is turned off. Accordingly, the above information can be stored in a volatile memory because the above information is information maintained only while the power supply device is turned on. The second information storage unit 166 can use a SRAM that functions as a general working memory.

According to one embodiment, the basic information that needs to be maintained when the power supply device is turned on/off can be stored in the non-volatile memory. Therefore, as described above, even though the power supply device is turned off, the basic information can be maintained without being volatilized. Since the portion of the memory area (refer to reference numeral 150 of FIG. 1) does not need to be allocated, it is possible to more efficiently use the limited memory resources of the memory area (refer to reference numeral 150 of FIG. 1).

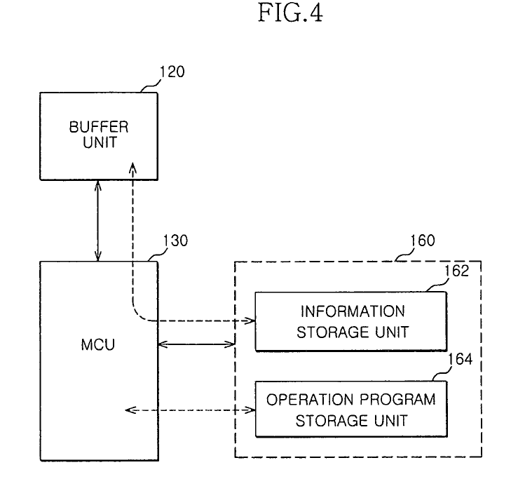

FIG. 4 is a block diagram of a relationship with an information storage area 160 according to another embodiment.

The information storage area 160 according to yet another embodiment can be configured to include an information storage unit 162 and an operation program storage unit 164. The information storage area can include the working memories that are separated from each other according to the attribute of the information. However, according to another embodiment, the information storage area can include one integrated working memory.

The operation program storage unit 164 is the same as that according to one embodiment, thus the description thereof will be omitted.

The information storage area 162 can store information that is needed when the MCU 130 executes commands. In addition information storage area 162 can store information that is not related to whether the power supply device is turned on or turned off, that is, information that needs to be maintained even when the power supply device is turned off.

The information storage area 162 can include a non-volatile memory. If the information storage area 162 has a predetermined size, information, which needs to be maintained while the MCU 130 executes commands and even when the power supply device is turned off, can be stored in the information storage unit 162.

This corresponds to an example of when a volatile memory area can be optionally excluded. The information, which needs to be maintained without being volatilized even after the power supply device is turned off, can be stored in a next-generation non-volatile memory area where a high-speed write operation can be performed.

As such, according to one embodiment, an address mapping information updating operation and an information storage operation, which are needed when the current operation is performed, can be performed at a relatively high speed. That is, if a next-generation non-volatile memory that has a relatively faster data processing speed than the flash memory is used as the storage memory, the operation can be controlled at a relatively high speed.

While certain embodiments have been described above, it will be understood that the embodiments described are by way of example only. Accordingly, the device and method described herein should not be limited based on the described embodiments. Rather, the devices and methods described herein should only be limited in light of the claims that follow when taken in conjunction with the above description and accompanying drawings.

What is claimed is:

1. A solid state storage system, comprising:
a memory area;
a controller configured to control the memory area; and
an information storage area controlled by the controller and configured to store logical address mapping information and physical address mapping information of the memory area.

2. The solid state storage system of claim 1,
wherein the information storage area is configured to maintain the logical address mapping information and the physical address mapping information, even when a power supply device is turned off.

3. The solid state storage system of claim 1,
wherein a speed of storing information in the information storage area is faster than a speed of storing information in the memory area.

4. The solid state storage system of claim 1,
wherein the information storage area includes a non-volatile random access memory (NVRAM).

5. The solid state storage system of claim 1, wherein the information storage area includes:
a first information storage unit configured to store the logical address mapping information and the physical address mapping information; and
a second information storage unit configured to store control signal information used to control the operation of the controller.

6. The solid state storage system of claim 5,
wherein the second information storage unit is configured to maintain the stored control signal information when a power supply device is turned on.

7. The solid state storage system of claim 5,
wherein the control signal information includes an interrupt flag, a status register, a stack pointer, and a program counter, which are signals used for controlling work order while the operation of the solid state storage system is performed.

8. A solid state storage system, comprising:
a memory area;
a controller configured to control the memory area; and
an information storage area controlled by the controller and configured to store erase count information of a block in the memory area.

9. The solid state storage system of claim 8,
wherein the information storage area is configured to maintain the erase count information of the block in the memory area when a power supply device is turned off.

10. The solid state storage system of claim 8,
wherein a speed of storing information in the information storage area is faster than a speed of storing information in the memory area.

11. The solid state storage system of claim 8,
wherein the information storage area includes a non-volatile random access memory (NVRAM).

12. The solid state storage system of claim 8, wherein the information storage area includes:
a first information storage unit configured to store the erase count information; and
a second information storage unit configured to store control signal information used to control the operation of the controller.

13. The solid state storage system of claim 12,
wherein the second information storage unit is configured to maintain the stored control signal information when a power supply device is turned on.

14. The solid state storage system of claim 12,
wherein the control signal information includes an interrupt flag, a status register, a stack pointer, and a program counter which are used to control work order when the operation of the solid state storage system is performed.
